(19) United States
(12) Patent Application Publication
(10) Pub. No.: US 2009/0313376 A1
(43) Pub. Date: Dec. 17, 2009

(54) METHOD AND APPARATUSES FOR ESTABLISHING A SESSION BETWEEN A CLIENT TERMINAL AND A MEDIA SUPPLY SYSTEM TO TRANSPORT A UNICAST MEDIA STREAM OVER AN IP NETWORK

(76) Inventors: Mats Cedervall, Harnosand (SE); Magnus Hallenstál, Taby (SE); Hans Carlsson, Vallentuna (SE)

Correspondence Address: ERICSSON INC., 6300 LEGACY DRIVE, M/S EVR 1-C-11, PLANO, TX, 75024, US

(21) Appl. No.: 12/303,242

(22) PCT Filed: Jun. 2, 2006
(86) PCT No.: PCT/EP2006/062880

§ 371 Date: Jun. 22, 2009

(51) Int. Cl. G06F 15/16

(52) U.S. Cl. 709/227; 709/231

(57) ABSTRACT

A method of setting up a session between a client terminal and a media supply system in order to transport a unicast media stream from the media supply system to the client terminal over an intervening IP network, the media supply system implementing the Real Time Streaming Protocol. The method comprises conducting a negotiation between the client terminal and the media supply system over an IP Multimedia Subsystem network in order to identify to the IP Multimedia Subsystem network the source and destination IP addresses and port numbers for the media stream, and subsequently sending Real Time Streaming Protocol messages from the client terminal to the media supply system in order to control the playout of media from the media supply system.

### TECHNICAL FIELD

The present invention relates to establishing and controlling an IP unicast service and is applicable in particular, though not necessarily, to video-on-demand services.

### BACKGROUND

IP television or IPTV is the name given to a range of services which allow television to be delivered over an IP network. Due to the flexible nature of an IP network, IPTV will allow for a much more personalised service to users, e.g. video-on-demand, with information delivered to users over unicast IP streams. However, to order and control these user specific services, the user would normally be expected to use his or her remote control whilst sitting in front of a Set-Top-Box/TV. Currently the predominant way of controlling these unicast streams is to use the real time streaming protocol (RTSP). RTSP does not specify a transport protocol but may be used, for example, to establish and control real-time transport protocol (RTP) media streams. RTSP is in many ways similar to the HTTP protocol used to request and exchange information over the WWW, but is tailored for streaming media such as audio and video. RTSP allows for a client to request particular media streams from a streaming server, and specifies commands such as PLAY and PAUSE. RTSP is well suited to the conventional set-top-box use case.

It is expected that users of mobile terminals such as mobile telephones will wish to avail themselves of IPTV services. Indeed, this is probably key to the business models of network operators currently installing high capacity cellular networks such as 3G networks. Within cellular networks, IPTV is a service which will likely be facilitated by the so-called IP Multimedia Subsystem (IMS). IMS is the technology defined by the Third Generation Partnership Project (3GPP) to provide IP Multimedia services over mobile communication networks (3GPP TS 22.228, TS 23.218, TS 23.228, TS 24.228, TS 24.229, TS 29.228, TS 29.229, TS 29.328 and TS 29.329 Releases 5 to 7), although the IMS architecture is such that its services can be accessed and controlled via other interfaces, for example the Internet. IMS makes use of the Session Initiation Protocol (SIP) to set up and control calls or sessions between user terminals, or user terminals and application servers. The Session Description Protocol (SDP), carried by SIP signalling, is used to describe and negotiate the media components of the session. Whilst SIP was created as a user-to-user protocol, IMS allows operators and service providers to control user access to services and to charge users accordingly.

It will be appreciated that IMS and RTSP can be considered as alternative approaches to the establishment and control of unicast streaming sessions. Whilst IMS provides a mechanism for controlling QoS and charging, as well as transcoder negotiation, RTSP supports trickplay and basic video-oriented commands.

### SUMMARY

According to a first aspect of the present invention there is provided a method of setting up a session between a client terminal and a media supply system in order to transport a unicast media stream from the media supply system to the client terminal over an intervening IP network, the media supply system implementing the Real Time Streaming Protocol, the method comprising:
conducting a negotiation between the client terminal and the media supply system over an IP Multimedia Subsystem network in order to identify to the IP Multimedia Subsystem network the source and destination IP addresses and port numbers for the media stream; and
subsequently sending Real Time Streaming Protocol messages from the client terminal to the media supply system in order to control the playout of media from the media supply system.

The media supply system may be implemented as one or more control servers plus one or more media unicast servers. In the case of video-on-demand, the former are video-on-demand control servers whilst the latter are video unicast servers.

Preferably, the IP Multimedia Subsystem network comprises a Proxy Call/Session Control Function (P-CSCF) allocated to the client terminal and through which all IMS/SIP signalling is routed.

Where the media supply system does not directly interface to the IP Multimedia Subsystem network, said negotiation may be carried out via a SIP application server of the IP Multimedia Subsystem network. The SIP application server provides for the translation of SIP messages received from the client terminal into Real Time Streaming Protocol messages for transmission to the media supply system.

Preferably, the IP Multimedia Subsystem network uses the identified source and destination IP addresses and port numbers to allocate resources for the unicast media stream. This will typically involve a Proxy Call/Session Control Function instructing a Border Gateway Function to open up a pinhole in respect of a media stream flowing between the source and destination IP addresses and port numbers.

The invention is applicable in particular to the case where the client terminal is a mobile terminal, for example a cellular telephone.

According to one embodiment of the present invention, the message flow associated with the negotiation step comprises:

A SIP INVITE sent from the client terminal to the SIP application server via a Proxy Call/Session Control Function;

An RTSP DESCRIBE sent from the SIP application server to the media supply system;

A 200 OK returned from the media supply system via the application server and the Proxy Call/Session Control Function.

In the case where the 200 OK identifies the source IP address and port number for the media source, this exchange completes the negotiation over the IMS. However, if this information is not contained in the 200 OK, the client terminal may send a SIP reINVITE to the application server via the Proxy Call/Session Control Function. The application server translates the reINVITE into an RTSP SETUP message and sends this to the media supply system. The media supply system returns a further 200 OK to the client terminal, via the application server and the Proxy Call/Session Control Function. The 200 OK contains the required address information which is observed by the Proxy Call/Session Control Function.

In certain embodiments of the invention, the media supply system has an interface to the IP Multimedia Subsystem, in which case the SIP INVITE, and optionally SIP reINVITE, messages are sent directly to the media supply system.

According to a second aspect of the present invention there is provided a Session Initiation Protocol application server having an interface to an IP Multimedia Subsystem network and comprising:
means for receiving a Session Initiation Protocol request from a client terminal over the IP Multimedia Subsystem network;
means for processing the received request to generate a Real Time Streaming Protocol message; and
means for forwarding said Real Time Streaming Protocol message to a media supply system.

Said Session Initiation Protocol request may be a Session Initiation Protocol INVITE, said means for processing being arranged to translate the message into a Real Time Streaming Protocol DESCRIBE.

The server may further comprise means for receiving a 200 OK response to said Real Time Streaming Protocol message from the media supply system, modifying the SDP of the response to include the source IP address and port number of a requested media stream, and sending the modified 200 OK to the client terminal.

Alternatively, the server may comprise means for receiving a 200 OK response to said Real Time Streaming Protocol message from the media supply system, for responding to the media supply system with a request for further information, for receiving a further 200 OK message containing the requested information and modifying the response before forwarding it to the client terminal.

Said Session Initiation Protocol request may be a Session Initiation Protocol reINVITE, said means for processing being arranged to translate the message into a Real Time Streaming Protocol SETUP.

According to a third aspect of the present invention there is provided a media supply system having an interface to an IP Multimedia Subsystem network and comprising:
means for receiving a Session Initiation Protocol request for a media stream from a client terminal over the IP Multimedia Subsystem network;
means for responding to receipt of said Session Initiation Protocol request by identifying to the IP Multimedia Subsystem network the source IP addresses and port numbers of the media stream; and
means for subsequently receiving and acting upon Real Time Streaming Protocol messages sent by the client terminal.

In an embodiment of the invention, the media supply system is a video-on-demand system.

According to a fourth aspect of the present invention there is provided a client terminal comprising:
first processing means for implementation IP Multimedia Subsystem/Session Initiation Protocol client functionality;
second processing means for implementing the Real Time Streaming Protocol for controlling a media supply system; and
third processing means for establishing a unicast media stream from the media supply system to the client terminal by using IP Multimedia Subsystem/Session Initiation Protocol signalling to inform the IP Multimedia Subsystem network of the source and destination IP addresses and port numbers for the media stream thereby allowing the IP Multimedia Subsystem to pass the media stream, and using Real Time Streaming Protocol messages to cause the media to be played out.

The client terminal may be a mobile terminal, for example a cellular telephone, or a fixed terminal.

### BRIEF DESCRIPTION OF THE DRAWINGS

FIG. 1 illustrates schematically an IPTV topology architecture;

FIG. 2 shows a signalling procedure for establishing a video-on-demand stream to a client terminal according to a first embodiment of the present invention;

FIG. 3 shows a signalling procedure for establishing a video-on-demand stream to a client terminal according to a second embodiment of the present invention; and

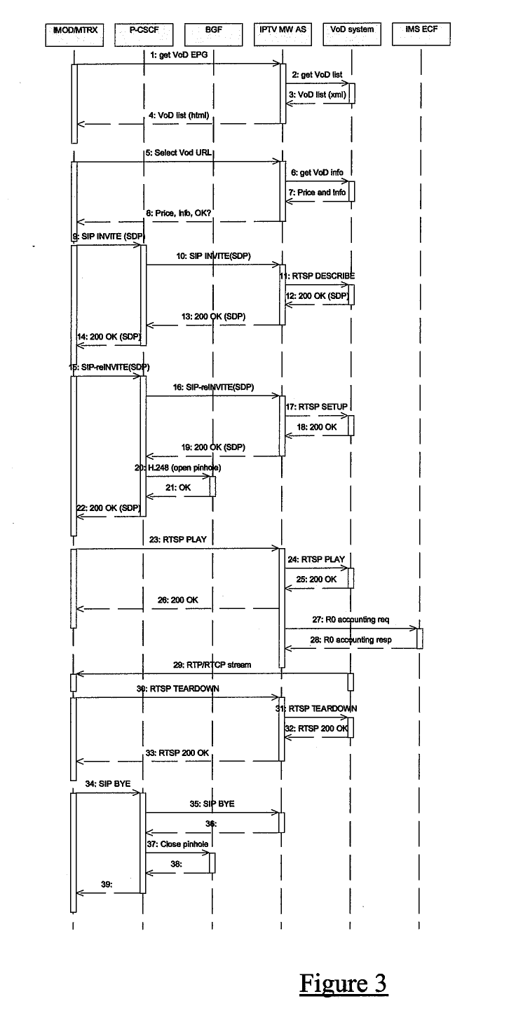

FIG. 4 shows a signalling procedure for establishing a video-on-demand stream to a client terminal according to a third embodiment of the present invention;

### DETAILED DESCRIPTION

A brief description of the architecture and operation of the IP Multimedia Subsystem (IMS) will aid in understanding embodiments of the present invention.

Call/Session Control Functions (CSCFs) operate as SIP proxies within the IMS. The 3GPP architecture defines three types of CSCFs: the Proxy CSCF (P-CSCF) which is the first point of contact within the IMS for a SIP client (typically residing in a user terminal); the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF.

A user registers with the IMS using the specified SIP REGISTER method. This is a mechanism for attaching to the IMS and announcing to the IMS the (IP) address at which a SIP user identity can be reached. The user receives a unique Uniform Resource Identifier (URI) from the S-CSCF to be used when it initiates a dialog. In 3GPP, when a SIP client performs a registration, the IMS authenticates the user (using the AKA procedure), and allocates a S-CSCF to that user from the set of available S-CSCFs. Whilst the criteria for allocating a S-CSCF is not specified by 3GPP, these may include load sharing and service requirements. It is noted that the allocation of an S-CSCF is key to controlling (and charging for) user access to IMS-based services.

During the registration process, it is the responsibility of the I-CSCF to select an S-CSCF if one is not already selected. The I-CSCF receives the required S-CSCF capabilities from the home network's Home Subscriber Server (HSS), and selects an appropriate S-CSCF based on the received capabilities. (It is noted that S-CSCF allocation is also carried out for a user by the I-CSCF in the case where the user is called by another party, and the user is not currently allocated an S-CSCF.) When a registered user subsequently sends a session request (e.g. SIP INVITE) to the IMS, the request will include the P-CSCF and S-CSCF URIs so that the P-CSCF is able to forward the request to the selected S-CSCF. This applies both on the originating and terminating sides (of the IMS). (For the terminating call the request will include the P-CSCF address and the User Equipment (UE) address.)

Within the IMS service network, Application Servers (ASs) are provided for implementing IMS service functionality. ASs provide services to end-users in an IMS system, and may be connected either as end-points over the 3GPP defined Mr interface, or “linked in” by an S-CSCF over the 3GPP defined ISC interface. In the latter case, Initial Filter Criteria (IFCs) are used by a S-CSCF to determine which ASs should be “linked in” during a SIP Session establishment. Different IFCs may be applied to different call cases. The IFCs are received by the S-CSCF from an HSS during the IMS registration procedure as part of a user's User Profile (UP). Certain ASs will perform actions dependent upon subscriber identities (either the called or calling subscriber, whichever is “owned” by the network controlling the AS). For example, in the case of call forwarding, the appropriate (terminating) application server will determine the new terminating party to which a call to a given subscriber will be forwarded.

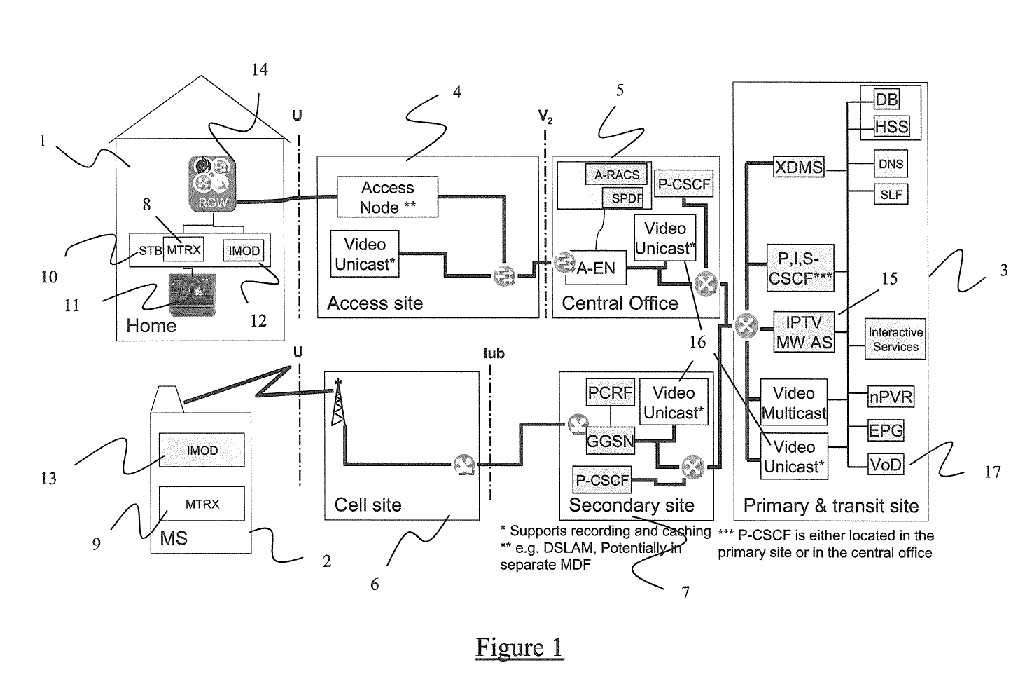

FIG. 1 presents an overview of the IPTV/IMS architecture illustrating the apparatus/functionality provisioned within the home 1 and the MS 2, which are attached respectively to the IMS 3 via a fixed access network 4/access network operator IMS network 5 and a wireless access network 6/Mobile operator IMS network 7. Network elements of interest here are:

MTRX—Media Transmission/Reception Part 8,9; The “traditional” Set Top Box functionalities in an IMS enabled Set Top Box 10, for example reception of MPEG2 and/or MPEG4 streams and conversion of such streams for delivery to a TV 11.

IMOD—Identity and IMS Module 12,13; The part of an IMS enabled Set Top Box that contains the basic IMS service logic and the ISIM. The IMOD could also be implemented in other devices in the home, e.g. the Residential Gateway (RGW) 14. The IMOD could also be implemented in a mobile phone, enabling remote access to TV services.

IPTV MW AS—IPTV Middleware SIP Application Server 15; The function that interacts between the IMS enabled STB and MS (and other IMS user devices) and the IPTV video servers. The IPTV MW AS also receives and processes HTTP and RTSP messages.

Video Unicast—the video unicast servers 16. These are the sources of unicast (streaming) media and are distributed across the IP network. In particular, video unicast servers are located in the primary and transit network and in the central office and secondary site.

VoD—Video-on-demand (control) server 17. This server controls access to and playout from the distributed video unicast servers.

MTRX and the IMOD entities will be present within STBs that are used to access the IPTV service via the IMS. In addition, and as illustrated in the FIG. 1, these entities are present within a Mobile Station (MS) or user terminal, which could for example be a cellular telephone. It will be appreciated that the MS may be present within an IMS network of an operator that is not the operator of the IPTV provider.

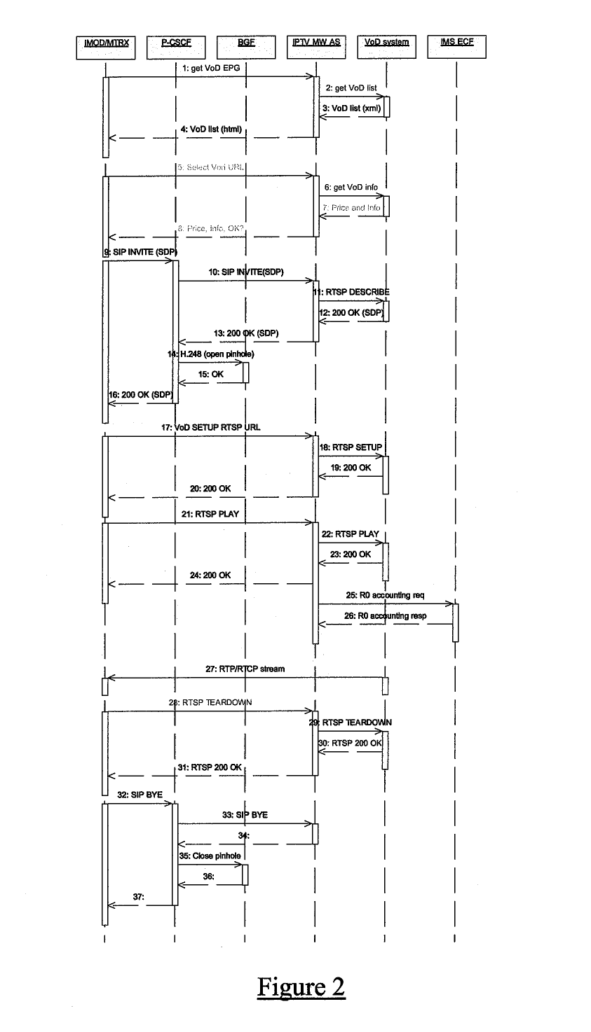

FIG. 2 illustrates a procedure for establishing and controlling a video-on-demand session between a client terminal and a unicast server over the IMS networks. In the figure, the client terminal is represented by the relevant functional entities; IMOD/MTRX, whilst the unicast server and the VoD node are combined into a single entity referred to as the “VoD system”. In the following discussion, the client terminal is assumed to be a mobile station (MS). All IP traffic sent to and from the MS is routed through a GPRS Gateway Support Node (GGSN) of the secondary site which enforces an access policy specified by a Proxy Call/Session Control Function (P-CSCF), the policy rules having been previously downloaded to the P-CSCF at user registration.

The procedure can be broken down into the following stages:

The client terminal includes a web browser, and knows the web address (URL) of the VoD system. Using the browser interface, the client acquires from the VoD system an electronic programming guide (EPG) detailing available streamed programs, as well as pricing information for a selected program.
1. The user makes a selection from the displayed EPG to obtain a VoD title list.
2. IPTV MW AS requests a VoD title list from the VoD system.
3. VoD system returns VoD title list in XML format.
4. IPTV MW AS builds and returns an HTML page to IMOD.
5. The user selects a VoD title, and sends an HTTP request to the IPTV MW AS.
6. The IPTV MW AS requests description information from the VoD system.
7. The VoD description is returned.
8. The IPTV MW AS returns an HTML page to the user, requesting confirmation that the price and title are acceptable to the user.

Using the SIP INVITE method, the client terminal invites the VoD system to join a SIP session. [It is assumed that the client terminal has previously registered with the IMS.]
9. Assuming that the user agrees to the displayed proposal, the IMOD sends a SIP INVITE message to invite the IPTV MW AS. The message contains an initial SDP as set out in Table 1, item “Step 9-10”. Items of interest in the example SDP are the IP address of the client terminal, “IP4 10.0.0.1”, a URL identifying the streaming media required, “RTSP://www.op.com/VoD/123456”, and the media transport protocol, “RTP”, and destination port number at the client terminal, “491”. [The SDP included in the SIP INVITE is essentially the same as the SDP that would be included in an RTSP DESCRIBE message to obtain details of a VoD service.]
10. When the SIP INVITE message passes through the P-CSCF, the P-CSCF inspects the SDP message and stores initial state information accordingly.
11. The MW-AS extracts the necessary information from the SIP INVITE message, i.e. the URL of the required media stream, constructs an RTSP DESCRIBE message, and sends this to the VoD system. The IPTV MW-AS stores the SDP info for later use. Example content of the DESCRIBE message is shown in Table 1 below, item “Step 11”.
12. A 200 OK message is returned from the VoD system. This message contains an SDP message describing relevant information about the session that is being established. It is assumed here that the message header contains the source IP address and port number for the media source. Example content is shown in Table 1 below, see item “Step 12”, where the source IP address for the requested media is “IP4 168.0.0.1”, and the source port number is “90”. The SDP also identifies the required bandwidth for the session, i.e. “3500” or 3.5 Mbits/second.
13. The IPTV MW AS incorporates the media source IP address and port number (from the message header) into the SDP, See Table 1 below, item “Step 13”.
14. When the 200 OK message passes through the P-CSCF it notes the necessary socket information (IP address and port number) from the SDP, along with the stored state information and informs a border gateway function BGF (i.e. GGSN) about the pinhole to open, via an H.248 request. See Figure below for SDP information.
15. The BGF opens the pinhole (IP/port source/dest configuration) and reserves the appropriate amount of bandwidth.
16. A 200 OK message is returned to IMOD.

The client terminal reverts to RTSP to reserve resources for the streaming session at the VoD system, and to cause the VoD system to play out the streamed media.
17. The IMOD sends an RTSP SETUP to IPTV MW AS using the control connection that already exists. An example message structure is illustrated in Table 1 below, see item “Step 17-18”.
18. The IPTV MW AS sends an RTSP SETUP message to VoD.
19. A 200 OK message is returned from the video server. An example message structure is shown in Table 1 below, see item “step 19-20”.
20. A 200 OK message is returned to IMOD.
21. The IMOD Starts playback by sending an RTSP PLAY command to the MW AS.
22. The IPTV MW AS performs relevant authentication and accounting (AA) actions and proxies the play request to the video server.
23. The video server responds with a 200 OK
24. The IPTV MW AS forwards the 200 OK to the IMOD.
25. IPTV MW AS performs an event accounting request to the IMS event charging function ECF.
26. A response is sent from the IMS ECF to the MW AS.

Streamed media and control signals are played out over the established session.
27. The MTRX receives RTP stream from video server.

Using RTSP, the session is terminated, and resources released at the VoD system.
28. The video session is torn down with RTSP TEARDOWN.
29. The command is proxied to the VoD system by the MW AS.
30. 200 OK.
31. 200 OK.

The SIP session is terminated and resources released.
32. The SIP session is closed with a SIP BYE.
33. Sip BYE.
34. 200 OK.
35. The pinhole is closed and bandwidth freed with an H.248 request.
36. OK.
37. 200 OK.

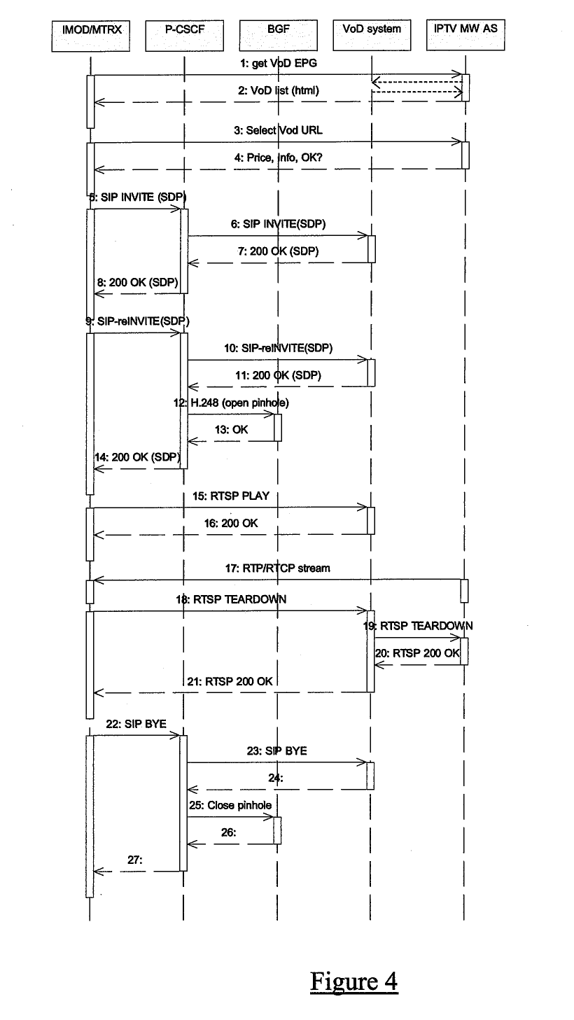

As already mentioned, the procedure of FIG. 2 assumes that the 200 OK message at step 12, sent from the VoD system to the IPTV MW AS, contains the IP address and port number of the media source. In practice, this is unlikely to be the case. In order to force the VoD system to provide this information to the client terminal, and the P-CSCF, the procedure illustrated in FIG. 4 may be implemented, where it is assumed that the SDP of the 200 OK (step 12) does not contain the IP address and port number of the media source. Upon receipt of the 200 OK, the client terminal will send at step 15 a reINVITE requesting further information on the media source. This message replaces the RTSP SETUP message of the procedure of FIG. 2, forcing the resource reservation request to go via the P-CSCF. The reINVITE message is “translated” at the IPTV MW AS into an RTSP SETUP message. The 200 OK response generated by the VoD server now contains the media source address and port number, and necessarily travels back to the client terminal via the P-CSCF. The P-CSCF is able to inform the BGF to open up the appropriate pinhole (steps 20 and 21). From step 23 onwards, the message flow is as described above with reference to FIG. 2.

The procedure of FIG. 4 may be simplified by enabling the IPTV MW AS to recognise when an initial 200 OK message returned by the VoD system is insufficient. In this case, the MW AS itself generates the necessary RTSP SETUP (step 17), avoiding the need for signalling steps 13 to 16.

FIG. 5 illustrates a signalling procedure associated with a further embodiment of the invention. According to this embodiment, the VoD system (i.e. VoD server) is IMS compatible, and there is no requirement to route IMS SIP signalling via an IPTV MW AS.

In the procedure of FIG. 5, it is assumed that the first 200 OK from the VoD system does not identify the media source and therefore that the reINVITE method is required (as per FIG. 4).

It will be appreciated by the person of skill in the art that various modifications may be made to the above described embodiments without departing from the scope of the present invention.

TABLE 1

Step 9-10:
IMOD−>MW AS:INVITE <.... SIP details skipped>

Content-Type: application/sdp
Content-Length: 56
v=0
o= 2890844526 2890842807 IN IP4 10.0.0.1
s=VoD1234
u=RTSP://www.op.com/VoD/123456
c=IN IP4 10.0.0.1
m=video 49170 RTP/AVP 98 32
a=rtpmap:98 H264/90000

Step 11:
MW AS−>VoD:
DESCRIBE RTSP://www.op.com/VoD/123456 RTSP/1.0

CSeq: 1

Step 12
VoD−>MW AS: RTSP/1.0 200 OK

CSeq: 1
Content-Type: application/sdp
Content-Length: 164
v=0
o=− 2890844256 2890842807 IN IP4 168.0.0.1
s=RTSP Session
i=An Example of RTSP Session Usage
a=control:RTSP://www.op.com/VoD/123456
t=0 0
m=video 9000 RTP/AVP 98
a=rtpmap:98 H264/90000
a=fmtp:98 profile-level-id=42A01E; packetization-mode=0;
sprop-parameter-sets=Z0IACpZTBYmI,aMljiA==
b=AS:3500

Step 13
MW AS−>IMOD:200 OK <SIP details skipped>

v=0
o=− 2890844256 2890842807 IN IP4 168.0.0.1
c=IN IP4 10.0.0.1
s=RTSP Session
i=An Example of RTSP Session Usage
a=control:RTSP://www.op.com/VoD/123456
t=0 0
m=video 9000 RTP/AVP 98
a=rtpmap:98 H264/90000
a=fmtp:98 profile-level-id=42A01E; packetization-mode=0;
sprop-parameter-sets=Z0IACpZTBYmI,aMljiA==
b=AS:3500

Step 17-18
IMOD->MW->VoD: SETUP rtsp://foo/twister/audio RTSP/1.0

CSeq: 2
Transport: RTP/AVP;unicast;client_port=49170-49171

Step 19-20
VoD−>MW−>IMOD: RTSP/1.0 200 OK

CSeq: 2
Transport: RTP/AVP;unicast;client_port=49170-49171;

server_port=9000-9001

Session: 12345678

1. A method of setting up a session between a client terminal and a media supply system in order to transport a unicast media stream from the media supply system to the client terminal over an intervening IP network, the media supply system implementing the Real Time Streaming Protocol, the method comprising:
conducting a negotiation between the client terminal and the media supply system via a SIP Application Server of an IP Multimedia Subsystem network for
identifying to the IP multimedia Subsystem network the source and destination IP addresses and port numbers for the media stream, the SIP application server
translating SIP messages received from the client terminal into Real Time Streaming Protocol messages for transmission to the media supply system; and
subsequently sending Real Time Streaming Protocol messages from the client terminal to the media supply system via said SIP Application Server to control the playout of media from the media supply system.

2. The method according to claim 1, the media supply system comprising one or more control servers plus one or more media unicast servers.

3. The method according to claim 2, wherein said media stream is a video-on-demand stream and each of the one or more control servers is a video-on-demand control server and each of the one or more media unicast servers is a video unicast server.

4. The method according to claim 1, the IP Multimedia Subsystem network comprising a Proxy Call/Session Control Function allocated to the client terminal and through which all IMS/SIP signalling is routed.

5. The method according to claim 1, wherein the IP Multimedia Subsystem network uses the identified source and destination IP addresses and port numbers to allocate resources for the unicast media stream.

6. The method according to claim 5, wherein a Proxy Call/Session Control Function instructs a Border Gateway Function to open up a pinhole in respect of a media stream flowing between the source and destination IP addresses and port numbers.

7. The method according to claim 1, said client terminal being a mobile terminal.

8. The method according to claim 1, said negotiation comprising the steps of:
sending a SIP INVITE sent from the client terminal to said SIP application server via a Proxy Call/Session Control Function;
sending an RTSP DESCRIBE from the SIP application server to the media supply system;
sending a 200 OK from the media supply system via the application server and the Proxy Call/Session Control Function.

9. The method according to claim 8, wherein said 200 OK identifies the source IP address and port number for the media source.

10. The method according to claim 8, wherein said 200 OK does not identify the source IP address and port number for the media source, and, in response to receiving the 200 OK, the client terminal sends a SIP reINVITE to the application server via the Proxy Call/Session Control Function, the application server translating the reINVITE into an RTSP SETUP message and sending this to the media supply system, whereupon the media supply system returns a further 200 OK to the client terminal, via the application server and the Proxy Call/Session Control Function, the further 200 OK containing the required address information which is observed by the Proxy Call/Session Control Function.

11. The method according to claim 8, wherein said 200 OK does not identify the source IP address and port number for the media source, and, in response to receiving the 200 OK, the application server sends an RTSP SETUP message to the media supply system, the media supply system returning a further 200 OK containing the required address information.

12. A Session Initiation Protocol application server having an interface to an IP Multimedia Subsystem network. the application server comprising:
means for receiving a Session Initiation Protocol request from a client terminal over the IP Multimedia Subsystem network;
means for processing the received request to generate a Real Time Streaming Protocol message; and
means for forwarding said Real Time Streaming Protocol message to a media supply system.

13. The application server according to claim 12, wherein said Session Initiation Protocol request is a Session Initiation Protocol INVITE, said means for processing being arranged to translate the message into a Real Time Streaming Protocol DESCRIBE.

14. The application server according to claim 12, the server comprising means for:
receiving a 200 OK response to said Real Time Streaming Protocol message from the media supply system,
modifying the SDP of the response to include the source IP address and port number of a requested media stream, and
sending the modified 200 OK to the client terminal.

15. The application server according to claim 12, the server comprising means for:
receiving a 200 OK response to said Real Time Streaming Protocol message from the media supply system,
responding to the media supply system with a request for further information,
receiving a further 200 OK message containing the requested information and modifying the response before forwarding it to the client terminal.

16. The application server according to claim 12, wherein said Session Initiation Protocol request is a Session Initiation Protocol reINVITE, said means for processing being arranged to translate the message into a Real Time Streaming Protocol SETUP.

17. A client terminal comprising:
first processing means for implementing IP Multimedia Subsystem/Session Initiation Protocol client functionality;
second processing means for implementing the Real Time Streaming Protocol for controlling a media supply system; and
third processing means for establishing a unicast media stream from the media supply system to the client terminal by using IP Multimedia Subsystem/Session Initiation Protocol signalling to inform the IP Multimedia Subsystem network of the source and destination IP addresses and port numbers for the media stream thereby allowing the IP Multimedia subsystem to pass the media stream, and using Real Time Streaming Protocol messages to cause the media to be played out.

18. The terminal according to claim 17, the terminal being a mobile terminal.
